(19) United States
(12) Patent Application Publication
(10) Pub. No.: US 2025/0373058 A1
(43) Pub. Date: Dec. 4, 2025

(54) BATTERY DISCHARGING CIRCUIT, CIRCUIT CONTROL METHOD, AND BATTERY DISCHARGING APPARATUS

(71) Applicant: Autel Intelligent Technology Corp., Ltd., Shenzhen (CN)

(72) Inventor: Weilin WANG, Shenzhen (CN)

(73) Assignee: Autel Intelligent Technology Corp., Ltd., Shenzhen, GD (CN)

(21) Appl. No.: 19/300,960

(22) Filed: Aug. 15, 2025

Related U.S. Application Data
(63) Continuation of application No. PCT/CN2024/073698, filed on Jan. 23, 2024.

(30) Foreign Application Priority Data
Feb. 15, 2023 (CN) 202310140710.3

(51) Int. Cl. H02J 7/00

(52) U.S. Cl. CPC H02J 7/00714; H02J 7/0063

(57) ABSTRACT

A battery discharging circuit includes a resistor configuration branch, a current sampling branch, a switch branch, a signal amplification branch and a controller. The resistor configuration branch is connected between a battery and the switch branch, the resistor configuration branch is connected with the controller. The current sampling branch is connected between the battery and the switch branch, and the current sampling branch outputs a sampling signal. The controller is connected with the signal amplification branch, and the controller outputs a voltage signal corresponding to a target discharging current of the battery. The signal amplification branch is connected between the switch branch and the switch branch, and the signal amplification branch outputs a regulation signal based on the sampling signal and the voltage signal. The switch branch regulates a turn-on degree of the switch branch based on a regulation signal. The battery is discharged through the switch branch.

### CROSS-REFERENCE TO RELATED APPLICATIONS

This application is a continuation of PCT patent Application No. PCT/CN2024/073698, filed on Jan. 23, 2024, which claims priority to Chinese Patent Application No. 202310140710.3, filed on Feb. 15, 2023. The entire disclosures of the aforementioned applications are incorporated herein by reference for all purposes.

### BACKGROUND

With the increasingly wide application of electric vehicles, there is an increasing demand for repair of batteries used for supplying power to the electric vehicles. During transportation of the batteries for repair, the batteries are required to be kept at a low power level to ensure safety. Then, based on different amounts of power of the batteries when needing to be repaired, there is a need to design a corresponding discharging device to discharge the batteries, so as to enable the batteries to be kept at the low power level.

Currently, it is a common way to achieve the discharging of the batteries in a mode of feeding the electric energy of the batteries back to the power grid. However, this way needs to pay a relatively high cost.

### SUMMARY

The present disclosure relates to the technical field of electronic circuits, and more particularly relates to a battery discharging circuit, a circuit control method, and a battery discharging apparatus.

According to a first aspect of the present disclosure, provided is a battery discharging circuit, including: a resistor configuration branch, a current sampling branch, a switch branch, a signal amplification branch and a controller; where a first end of the resistor configuration branch is connected with a first end of a battery, a second end of the resistor configuration branch is connected with a first end of the switch branch, a first end of the current sampling branch is connected with a second end of the battery, a second end of the current sampling branch is respectively connected with a second end of the switch branch and a second end of the signal amplification branch, a first end of the signal amplification branch and a third end of the resistor configuration branch are both connected with the controller, and a third end of the signal amplification branch is connected with a third end of the switch branch; the resistor configuration branch is controlled by the controller and configured as a first preset resistor; the current sampling branch is used for sampling a discharging current of the battery and outputting a sampling signal; the controller is used for outputting a voltage signal corresponding to a target discharging current of the battery; the signal amplification branch is used for receiving the sampling signal and the voltage signal and outputting a regulation signal; the switch branch is used for receiving the regulation signal and regulating a turn-on degree of the switch branch based on the regulation signal; and the battery is discharged through the first preset resistor and the switch branch, and the discharging current of the battery has a positive correlation with the turn-on degree of the switch branch.

According to a second aspect of the present disclosure, provided is a circuit control method, used for controlling the battery discharging circuit according to the first aspect. The method includes: switching a connection relationship between resistor assemblies in N resistor assemblies of the resistor configuration branch to obtain M connection states of the N resistor assemblies, where M and N are both integers ≥1; for one or more connection states of the M connection states, changing a number of effective resistors in the N resistor assemblies, determining a resistor set in the one or more connection states, and obtaining M resistor sets in the M connection states; determining, based on a preset target set, a first resistor set matching the preset target set in the M resistor sets; and acquiring a first preset resistor in the first resistor set, where the battery is discharged through the first preset resistor.

According to a third aspect of the present disclosure, provided is a controller, including: at least one processor and a memory communicatively connected with the at least one processor, where the memory stores instructions executable by the at least one processor, and the instructions are executed by the at least one processor to cause the at least one processor to execute the method according to the second aspect.

According to a fourth aspect of the present disclosure, provided is a battery discharging apparatus, including the battery discharging circuit according to the first aspect and/or the controller according to the second aspect.

### BRIEF DESCRIPTION OF DRAWINGS

One or more embodiments are exemplarily illustrated by way of figures in the accompanying drawings corresponding to the embodiments, these exemplary illustrations do not constitute limitation on the embodiments, elements having the same reference numerals in the accompanying drawings are represented as similar elements, and the figures in the accompanying drawings do not constitute scale limitation unless otherwise specifically stated.

FIG. 1 is a schematic structural diagram of a battery discharging circuit according to an embodiment of the present disclosure;

FIG. 2 is a schematic structural diagram of the battery discharging circuit according to another embodiment of the present disclosure;

FIG. 3 is a schematic structural diagram of the battery discharging circuit according to yet another embodiment of the present disclosure;

FIG. 4 is a schematic structural diagram of the battery discharging circuit according to still yet another embodiment of the present disclosure;

FIG. 5 is a schematic structural diagram of the battery discharging circuit according to still yet another embodiment of the present disclosure;

FIG. 6 is a schematic structural diagram of the battery discharging circuit according to still yet another embodiment of the present disclosure;

FIG. 7 is a schematic diagram of a circuit structure of a signal amplification branch according to an embodiment of the present disclosure;

FIG. 8 is flowchart of a circuit control method according to an embodiment of the present disclosure;

FIG. 9 is a schematic diagram of one embodiment of step 803 shown in FIG. 8 according to an embodiment of the present disclosure;

FIG. 10 is a schematic diagram of one embodiment of step 804 shown in FIG. 8 according to an embodiment of the present disclosure;

FIG. 11 is a schematic diagram of one embodiment after step 804 shown in FIG. 8 is executed according to an embodiment of the present disclosure;

FIG. 12 is a schematic diagram of a first difference value according to an embodiment of the present disclosure; and

FIG. 13 is a schematic structural diagram of a controller according to an embodiment of the present disclosure.

### DETAILED DESCRIPTION

In order that the objectives, technical solutions and advantages of the embodiments of the present disclosure will become clearer, a clear and complete description of the technical solutions in the embodiments of the present disclosure will be rendered with reference to the accompanying drawings in the embodiments of the present disclosure. Obviously, the described embodiments are some but not all of the embodiments of the present disclosure. Based on the embodiments in the present disclosure, all other embodiments obtained by a person ordinarily skilled in the art without involving any inventive effort fall within the scope of protection of the present disclosure.

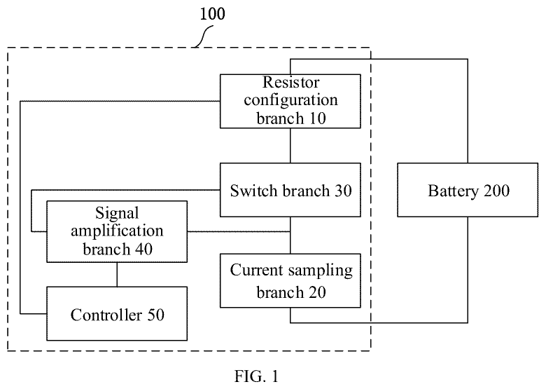

FIG. 1 is a schematic structural diagram of a battery discharging circuit according to an embodiment of the present disclosure. As shown in FIG. 1, the battery discharging circuit 100 includes a resistor configuration branch 10, a current sampling branch 20, a switch branch 30, a signal amplification branch 40 and a controller 50;

where a first end of the resistor configuration branch 10 is connected with a first end of a battery 200, a second end of the resistor configuration branch 10 is connected with a first end of the switch branch 30, and a third end of the resistor configuration branch 10 and a first end of the signal amplification branch 40 are both connected with the controller 50. A first end of the current sampling branch 20 is connected with a second end of the battery 200, and a second end of the current sampling branch 20 is respectively connected with a second end of the switch branch 30 and a second end of the signal amplification branch 40. A third end of the signal amplification branch 40 is connected with a third end of the switch branch 30.

In some embodiments, the resistor configuration branch 10 is controlled by the controller 50 and configured as a first preset resistor. The current sampling branch 20 is used for sampling a discharging current of the battery 200 and outputting a sampling signal at the second end of the switch branch 30 based on the discharging current of the battery 200. The controller 50 is used for outputting a voltage signal corresponding to a target discharging current of the battery 200 to the signal amplification branch 40. The signal amplification branch 40 is used for receiving the sampling signal and the voltage signal and outputting a regulation signal to the third end of the switch branch 30 based on the sampling signal and the voltage signal. The switch branch 30 is used for receiving the regulation signal and regulating a turn-on degree of the switch branch 30 based on the regulation signal, where an equivalent resistance of the switch branch 30 has a negative correlation with a turn-on degree thereof, that is, the equivalent resistance of the switch branch 30 decreases as the turn-on degree of the switch branch 30 increases. The battery is discharged through the first preset resistor and the switch branch 30. The discharging current of the battery 200 has a positive correlation with the turn-on degree of the switch branch 30, that is, the discharging current of the battery 200 increases as the turn-on degree of the switch branch 30 increases.

In a practical application, when it is necessary to control the battery 200 to be discharged, on the one hand, the controller 50 controls the resistor configuration branch 10 and configures the resistor configuration branch 10 as the first preset resistor. The battery 200 may be discharged through the first preset resistor. On the other hand, the battery 200 is also discharged through the switch branch 30. In the above manner, the process of consuming the discharging electric energy of the battery 200 through the first preset resistor and the switch branch 30, that is, the process of discharging the battery 200 is achieved. Furthermore, the process is achieved by adopting a relatively simple circuit structure, which requires a relatively low cost with respect to a mode of feeding the electric energy of the battery 200 back to the power grid in the related art.

In addition, by regulating the turn-on degree of the switch branch 30, the discharging current of the battery 200 can also be regulated, which is beneficial to maintaining the battery 200 to be discharged quickly and stably, and improving the working efficiency and stability of the battery discharging circuit 100. In an embodiment, the current sampling branch 20 outputs the sampling signal to the signal amplification branch 40 based on the discharging current of the battery 200. The controller 50 outputs the voltage signal corresponding to the target discharging current of the battery 200, where the target discharging current is a preset discharging current. The signal amplification branch 40 outputs the regulation signal to the switch branch 30 based on the sampling signal and the voltage signal, so as to regulate the turn-on degree of the switch branch 30, and further regulate the equivalent resistance when the switch branch 30 is turned on. Since the switch branch 30 has different turn-on degrees, it can be equivalent to resistors having different resistance values. According to the Ohm's law, when the resistance value of the switch branch 30 changes, the current flowing through the switch branch 30 also changes, and the current flowing through the switch branch 30 is also the discharging current of the battery 200. From the foregoing, it can be seen that the discharging current of the battery 200 can be regulated by regulating the turn-on degree of the switch branch 30.

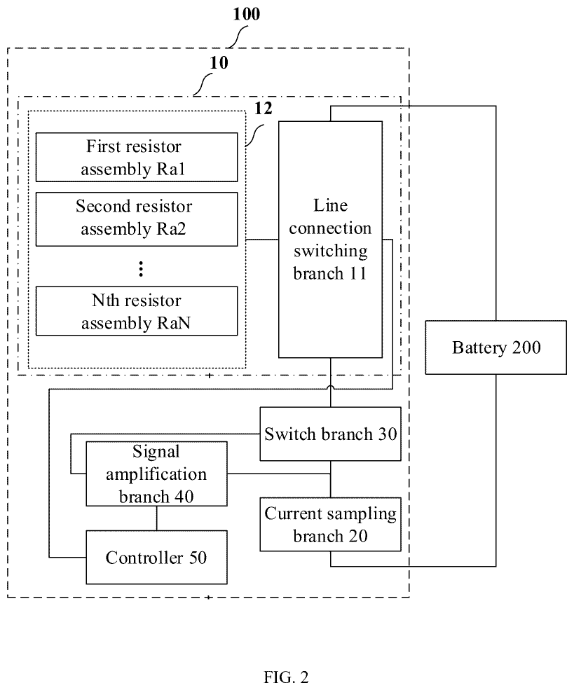

In some embodiments, as shown in FIG. 2, the resistor configuration branch 10 includes N resistor assemblies 12 and a line connection switching branch 11. Any resistor assembly in the N resistor assemblies 12 includes at least one resistor, and N is an integer ≥1. The N resistor assemblies 12 include a first resistor assembly Ra1, a second resistor assembly Ra2 . . . and an Nth resistor assembly RaN;

where the line connection switching branch 11 is respectively connected with the N resistor assemblies 12, the controller 50, a first end of the battery 200, and the first end of the switch branch 30. The line connection switching branch 11 is controlled by the controller 50. The line connection switching branch 11 is used for switching a connection relationship between different resistor assemblies in the N resistor assemblies 12 and generating the first preset resistor.

In an embodiment, the controller 50 can switch a connection relationship between the first resistor assembly Ra1, the second resistor assembly Ra2 . . . and the Nth resistor assembly RaN by controlling the line connection switching branch 11. When the connection relationship between the first resistor assembly Ra1, the second resistor assembly Ra2 . . . and the Nth resistor assembly RaN has been determined, the whole of the first resistor assembly Ra1, the second resistor assembly Ra2 . . . and the Nth resistor assembly RaN is taken as an equivalent resistor. When the connection relationship between the first resistor assembly Ra1, the second resistor assembly Ra2 . . . and the Nth resistor assembly RaN changes, the equivalent resistor corresponding to the whole of the first resistor assembly Ra1, the second resistor assembly Ra2 . . . and the Nth resistor assembly RaN also changes. Thus, by switching the connection relationship between the first resistor assembly Ra1, the second resistor assembly Ra2 . . . and the Nth resistor assembly RaN, one or more equivalent resistors can be obtained. The first preset resistor may be determined from these equivalent resistors. For example, the controller 50 controls the line connection switching branch 11 to enable the first resistor assembly Ra1, the second resistor assembly Ra2 . . . and the Nth resistor assembly RaN to be sequentially connected in series, and then the first preset resistor may be the equivalent resistor of the first resistor assembly Ra1, the second resistor assembly Ra2 . . . and the Nth resistor assembly RaN which are connected in series.

In this embodiment, by switching the connection relationship between the first resistor assembly Ra1, the second resistor assembly Ra2 . . . and the Nth resistor assembly RaN, different first preset resistors can be obtained, so as to satisfy the resistance required in different application scenes, which is beneficial to improving the applicability of the resistor configuration branch 10.

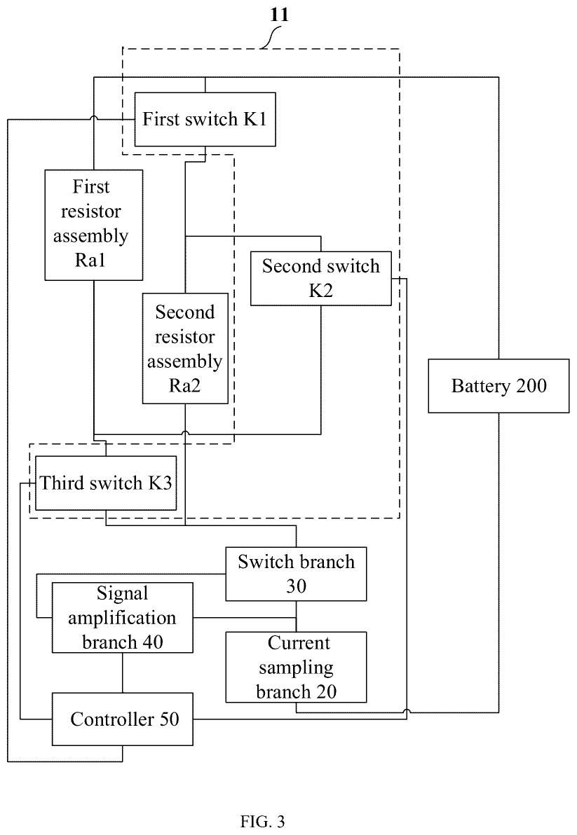

In some embodiments, as shown in FIG. 3, the N resistor assemblies 12 include a first resistor assembly Ra1 and a second resistor assembly Ra2, and the line connection switching branch 11 includes a first switch K1, a second switch K2 and a third switch K3;

where a first end of the first resistor assembly Ra1 is respectively connected with a first end of the first switch K1 and the first end of the battery 200, a second end of the first switch K1 is respectively connected with a first end of the second resistor assembly Ra2 and a first end of the second switch K2, a second end of the second switch K2 is respectively connected with the first end of the first resistor assembly Ra1 and a first end of the third switch K3, a second end of the third switch K3 is connected with a second end of the second resistor assembly Ra2 and the first end of the switch branch 30, and the first switch K1, the second switch K2 and the third switch K3 are all connected with the controller 50.

In an embodiment, the controller 50 switches a connection relationship between the first resistor assembly Ra1 and the second resistor assembly Ra2 by controlling the turn-on and turn-off of the first switch K1, the second switch K2 and the third switch K3, and first preset resistors having different resistance values may be obtained. For example, the controller 50 controls the first switch K1 and the third switch K3 to be turned on and controls the second switch K2 to be turned off, and then the first resistor assembly Ra1 and the second resistor assembly Ra2 are connected in parallel, and the first preset resistor is the equivalent resistor after the first resistor assembly Ra1 and the second resistor assembly Ra2 are connected in parallel. For another example, the controller 50 controls the second switch K2 to be turned on and controls the first switch K1 and the third switch K3 to be turned off, and then the first resistor assembly Ra1 and the second resistor assembly Ra2 are connected in series, and the first preset resistor is the equivalent resistor after the first resistor assembly Ra1 and the second resistor assembly Ra2 are connected in series.

It will be understood that in this embodiment, N=2 is taken as an example, and in other embodiments, N may be selected in other manners, so that the switches in the line connection switching branch 11 also need to be adjusted accordingly, and the specific adjustment manner may refer to the manner shown in FIG. 3, which will not be described in detail herein.

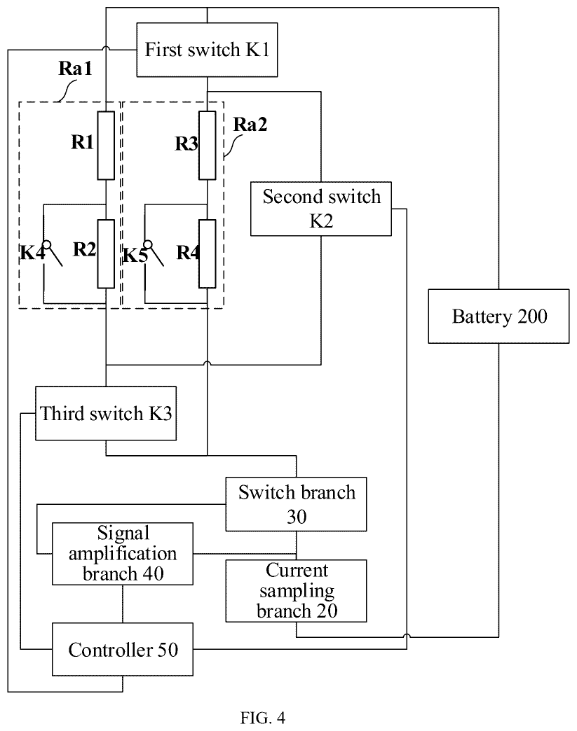

In some embodiments, as illustrated in FIG. 4, the first resistor assembly Ra1 includes a first resistor R1, a second resistor R2 and a fourth switch K4, and the second resistor assembly Ra2 includes a third resistor R3, a fourth resistor R4 and a fifth switch K5;

where the first resistor R1 is connected in series with the second resistor R2, the second resistor R2 is connected in parallel with the fourth switch K4, a non-series connection end of the first resistor R1 is the first end of the first resistor assembly Ra1, a non-series connection end of the second resistor R2 is the second end of the first resistor assembly Ra1, the third resistor R3 is connected in series with the fourth resistor R4, the fourth resistor R4 is connected in parallel with the fifth switch K5, a non-series connection end of the third resistor R3 is the first end of the second resistor assembly Ra2, and a non-series connection end of the fourth resistor R4 is the second end of the second resistor assembly Ra2.

In this embodiment, the case where both the first resistor assembly Ra1 and the second resistor assembly Ra2 include two resistors is taken as an example, while in other embodiments, each resistor assembly may include more or fewer resistors, and the first resistor assembly Ra1 and the second resistor assembly Ra2 may be the same or different.

In this embodiment, when the fourth switch K4 is turned off, a resistor after the first resistor R1 and the second resistor R2 are connected in series is the equivalent resistor of the first resistor assembly Ra1, and at this time, the effective resistors are the first resistor R1 and the second resistor R2; and when the fourth switch K4 is turned on, the second resistor R2 is short-circuited, the first resistor R1 is the equivalent resistor of the first resistor assembly Ra1, and at this time, the effective resistor is the first resistor R1. Likewise, when the fifth switch K5 is turned off, a resistor after the third resistor R3 and the fourth resistor R4 are connected in series is the equivalent resistor of the second resistor assembly Ra2, and at this time, the effective resistors are the third resistor R3 and the fourth resistor R4; and when the fifth switch K5 is turned on, the fourth resistor R4 is short-circuited, and the third resistor R3 is the equivalent resistor of the second resistor assembly Ra2, and at this time, the effective resistor is the third resistor R3.

Therefore, by controlling the turn-on or turn-off of the fourth switch K4 and the fifth switch K5, the equivalent resistor of the first resistor assembly Ra1 or the second resistor assembly Ra2 can be changed, so that more first preset resistors having different resistance values may be obtained, and the application scene which can be satisfied is also increased, which is beneficial to further improving the applicability of the battery discharging circuit.

In some embodiments, referring to FIG. 5 in conjunction with FIG. 1, the current sampling branch 20 includes a first sampling resistor RC1.

In an embodiment, a first end of the first sampling resistor RC1 is connected with a second end of the battery 200, and a second end of the first sampling resistor RC1 is connected with a second end of the switch branch 30. The first sampling resistor RC1 is used for converting a current output by the battery 200 into a voltage, and inputting the voltage to the signal amplification branch 40.

In a first example, as shown in FIG. 5, the switch branch 30 includes a first switch transistor Q1;

where a first end of the first switch transistor Q1 is connected with the third end of the signal amplification branch 40 (namely, an end of the signal amplification branch 40 which outputs the regulation signal), a second end of the first switch transistor Q1 is connected with the second end of the current sampling branch 20, and a third end of the first switch transistor Q1 is connected with the second end of the resistor configuration branch 10.

In some embodiments, a switching element such as an IGBT switch transistor or an MOS transistor may be selected as the first switch transistor Q1, which is not specifically limited in the embodiment of the present disclosure. Taking the first switch transistor Q1 being the IGBT switch transistor as an example, a gate electrode of the IGBT switch transistor is the first end of the first switch transistor Q1, an emission electrode of the IGBT switch transistor is the second end of the first switch transistor Q1, and a collector electrode of the IGBT switch transistor is the third end of the first switch transistor Q1.

Taking the first switch transistor Q1 being the IGBT switch transistor as an example, when the voltage of the regulation signal output by the signal amplification branch 40 enables the IGBT switch transistor to work in an adjustable resistance region, with the increase of the voltage of the regulation signal, a turn-on degree of the IGBT switch transistor increases, and a resistance value of the IGBT switch transistor decreases; and with the decrease of the voltage of the regulating signal, the turn-on degree of the IGBT switch transistor decreases, and the resistance value of the IGBT switch transistor increases. However, when the voltage of the regulation signal increases to enable the IGBT switch transistor to work in a saturation region, the IGBT switch transistor only functions as a switch, where the turn-on degree of the IGBT switch transistor corresponds to the turn-on degree of the switch branch 30.

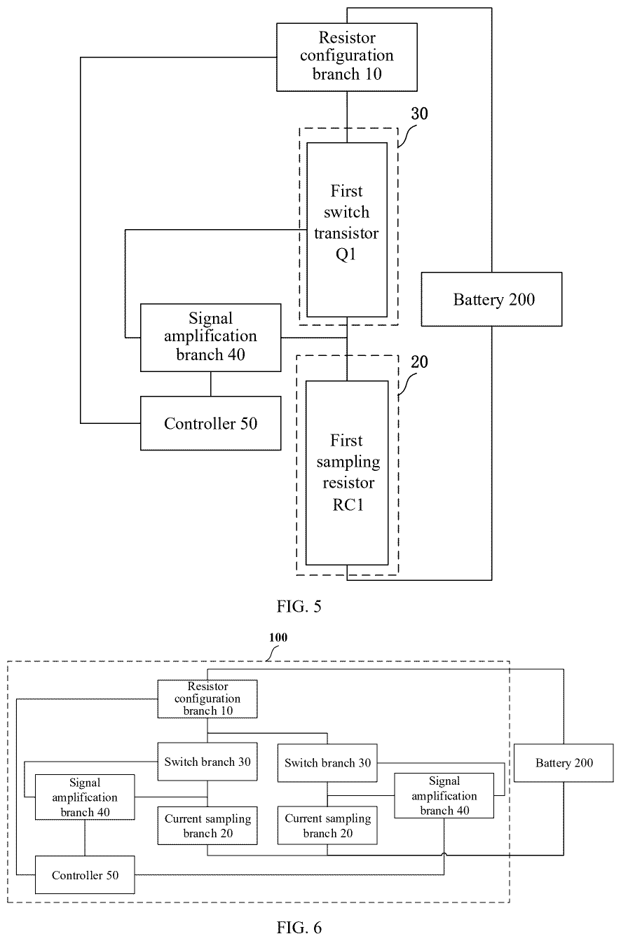

In some other embodiments, a plurality of switch branches, a plurality of current sampling branches and a plurality of signal amplification branches may be provided to meet the higher discharging power requirements of the battery 200, where one switch branch is connected with one current sampling branch and one signal amplification branch. For example, as shown in FIG. 6, a schematic diagram of two switch branches, two current sampling branches and two signal amplification branches is illustratively shown. The connection relationship between various branches may refer to FIG. 6, which will not be described in detail herein. In this embodiment, the two switch branches 30 are both capable of consuming the electrical energy discharged by the battery, and the discharging current of the battery 200 is the sum of the currents flowing through the two switch branches 30.

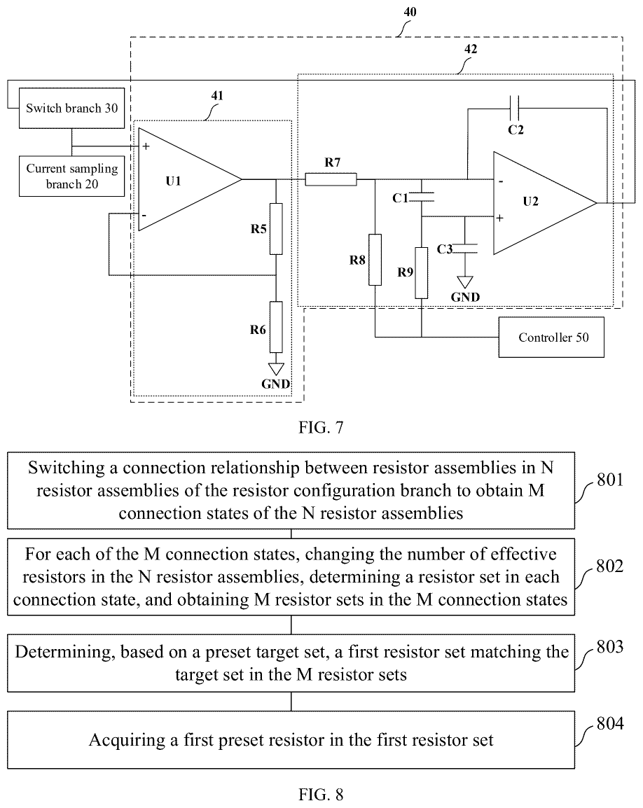

In some embodiments, as shown in FIG. 7, the signal amplification branch 40 includes a first amplification assembly 41 and a second amplification assembly 42;

where a first end of the first amplification assembly 41 is connected with the second end of the switch branch 30 and the second end of the current sampling branch 20, and a second end of the first amplification assembly 41 is connected with the first end of the second amplification assembly 42. A third end of the second amplification assembly 42 is connected with the third end of the switch branch 30. A second end of the second amplification assembly 42 is connected with the controller 50.

In an embodiment, the first amplification assembly 41 is used for receiving the sampling signal and inputting the sampling signal to the second amplification assembly 42 after amplifying the sampling signal. Since in a practical application, the current sampling branch 20 typically adopts a sampling resistor having a relatively small resistance value to convert the current into the voltage, a numerical value of the voltage converted by the current sampling branch 20 is also relatively small. It is necessary to amplify the numerical value of the voltage and then perform subsequent operation, so as to prevent the occurrence of abnormal situations such as signal mis-detection or signal detection errors due to the relatively small numerical value of the voltage, which is beneficial to improving the stability of the circuit working.

The second amplification assembly 42 is used for outputting the regulation signal based on the voltage signal output by the controller 50 and the amplified sampling signal. The controller 50 outputs the voltage signal corresponding to the target discharging current, namely, the voltage signal is taken as a reference signal. The regulation signal is output based on a comparison result obtained by comparison and amplification of the reference signal and the actual sampling signal. The regulation signal is used for regulating the turn-on degree of the switch branch 30 to regulate the discharging current of the battery 200, and it can be achieved that the discharging current of the battery 200 is finally regulated to be close to or equal to the target discharging current.

In an embodiment, the first amplification assembly 41 includes a first operational amplifier U1, a fifth resistor R5 and a sixth resistor R6;

where a first input end of the first operational amplifier U1 is connected with the second end of the switch branch 30, a second input end of the first operational amplifier U1 is connected with a first end of the fifth resistor R5 and a first end of the sixth resistor R6, an output end of the first operational amplifier U1 is connected with a second end of the fifth resistor R5 and the first end of the second amplification assembly 42, and a second end of the sixth resistor R6 is grounded. In this embodiment, the case where the first input end of the first operational amplifier U1 is a non-inverting input end and the second input end thereof is an inverting input end is taken as an example.

In an embodiment, the first amplification assembly 41 composed of the first operational amplifier U1, the fifth resistor R5 and the sixth resistor R6 can amplify the sampling signal on the current sampling branch 20, and an amplification factor is determined by resistance values of the fifth resistor R5 and the sixth resistor R6.

In an embodiment, the second amplification assembly 42 includes a seventh resistor R7, an eighth resistor R8, a ninth resistor R9, a first capacitor C1, a second capacitor C2, a third capacitor C3 and a second operational amplifier U2;

where a first end of the seventh resistor R7 is connected with the second end of the first amplification assembly 41, a second end of the seventh resistor R7 is respectively connected with a first end of the eighth resistor R8, a first end of the first capacitor C1, a first end of the second capacitor C2 and a second input end of the second operational amplifier U2, a second end of the eighth resistor R8 is respectively connected with a first end of the ninth resistor R9 and the controller 50, a second end of the ninth resistor R9 is respectively connected with a second end of the first capacitor C1, a first end of the third capacitor C3 and a first input end of the second operational amplifier U2, an output end of the second operational amplifier U2 is respectively connected with a second end of the second capacitor C2 and the third end of the switch branch 30, and a second end of the third capacitor C3 is grounded. In this embodiment, the case where the first input end of the second operational amplifier U2 is a non-inverting input end and the second input end thereof is an inverting input end is taken as an example.

In an embodiment, if there is a difference value between the amplified sampling signal and the voltage signal output by the controller 50, namely, the voltages at the first input end and the second input end of the second operational amplifier U2 are not equal, the regulation signal output by the second operational amplifier U2 can act on the second input end of the second operational amplifier U2 through the feedback of the second capacitor C2, so as to automatically regulate the voltages at the first input end and the second input end of the second operational amplifier U2 to be equal. That is, the greater the difference value between the amplified sampling signal and the voltage signal, the greater the voltage of the output regulation signal, so that the voltages at the first input end and the second input end of the second operational amplifier U2 can be regulated to be equal. Then, the greater the voltage value of the regulation signal, the greater the turn-on degree of the switch branch 30, and the smaller the resistance value of the switch branch 30, the discharging current of the battery 200 can be increased to reduce the difference value between the amplified sampling signal and the voltage signal, namely, reduce the voltage difference between the first input end and the second input end of the second operational amplifier U2. The above process is continuously repeated automatically until the voltages at the first input end and the second input end of the second operational amplifier U2 are equal. In the above manner, the process of automatically regulating the switch branch 30 based on the voltage signal output by the controller 50 can be achieved to achieve the discharging current of the battery 200 being the target discharging current corresponding to the voltage signal.

The battery discharging circuit provided by the present disclosure includes the resistor configuration branch, the current sampling branch, the switch branch, the signal amplification branch and the controller. When it is necessary to control the battery to be discharged, on the one hand, the controller controls the resistor configuration branch, the resistor configuration branch may be configured as the first preset resistor, and the battery is discharged through the first preset resistor; and on the other hand, the battery is also discharged through the switch branch. Thus, the process of discharging the battery is achieved, and is achieved by adopting a relatively simple circuit structure, which requires a relatively low cost with respect to a mode of feeding electric energy of the battery back to the power grid in the related art. Secondly, the current sampling branch outputs the sampling signal at the second end of the switch branch based on the discharging current of the battery. The controller outputs the voltage signal corresponding to the target discharging current of the battery. The signal amplification branch outputs the regulation signal to the third end of the switch branch based on the sampling signal and the voltage signal. Then, the switch branch may regulate the turn-on degree of the switch branch based on the regulation signal, so as to regulate the discharging current of the battery, which is beneficial to maintaining the battery to be discharged quickly and stably, and improving the efficiency and stability of the battery discharging circuit.

FIG. 8 is flowchart of a circuit control method according to an embodiment of the present disclosure. The circuit control method is used for controlling the battery discharging circuit in any of the embodiments of the present disclosure. As shown in FIG. 8, the circuit control method includes the following steps.

Step 801: switching a connection relationship between resistor assemblies in N resistor assemblies of the resistor configuration branch to obtain M connection states of the N resistor assemblies;

where M and N are both integers ≥1. The structure shown in FIG. 3 is taken as an example. At this time, N=2. It can be seen from the above example that if the first switch K1 and the third switch K3 in the line connection switching branch are controlled to be turned on and the second switch K2 is turned off, the connection relationship between the first resistor unit Ra1 and the second resistor unit Ra2 is switched to be connected in parallel. The first resistor unit Ra1 and the second resistor unit Ra2 which are connected in parallel are in a first connection state.

If the first switch K1 and the third switch K3 in the line connection switching branch are controlled to be turned off and the second switch K2 is turned on, the connection relationship between the first resistor unit Ra1 and the second resistor unit Ra2 is switched to be connected in series. The first resistor unit Ra1 and the second resistor unit Ra2 which are connected in series are in a second connection state. Then M=2 at this time.

It will be appreciated that in the structure shown in FIG. 3, only N=2 is taken as an example. However, when N is other numerical values, the number of connection states which can be obtained is also different, which will not be described in detail herein. Secondly, in this embodiment, only one example of M=N=2 is illustratively shown, while in other embodiments, M may be greater than N or less than N, which may be set according to the situations of practical applications, which is not specifically limited in the embodiment of the present disclosure.

Step 802: for each of the M connection states, changing the number of effective resistors in the N resistor assemblies, determining a resistor set in each connection state, and obtaining M resistor sets in the M connection states.

In an embodiment, for each of the M connection states, the number of effective resistors in the N resistor assemblies is changed, and then at least one equivalent resistor may be obtained in each connection state. A set of all equivalent resistors obtained in each connection state is the resistor set in each connection state. Since there are a total of M connection states, a total of M resistor sets may be obtained.

The structure shown in FIG. 4 is taken as an example. It can be seen from the above content that N=M=2 at this time. There may be a total of two connection states. The first connection state is that the first resistor unit Ra1 and the second resistor unit Ra2 are connected in parallel; and the second connection state is that the first resistor unit Ra1 and the second resistor unit Ra2 are connected in series.

With regard to the first connection state, when the fourth switch K4 and the fifth switch K5 are both turned on, the number of effective resistors is two, and the effective resistors are the first resistor R1 and the third resistor R3. At this time, the equivalent resistor is a resistor after the first resistor R1 and the third resistor R3 are connected in parallel, and is denoted as an equivalent resistor Re1.

When the fourth switch K4 is turned on and the fifth switch K5 is turned off, the number of effective resistors is three, and the effective resistors are the first resistor R1, the third resistor R3 and the fourth resistor R4, respectively. At this time, the equivalent resistor is a resistor after a circuit obtained after the third resistor R3 and the fourth resistor R4 are connected in series and the first resistor R1 are connected in parallel, and is denoted as an equivalent resistor Re2.

When the fourth switch K4 is turned off and the fifth switch K5 is turned on, the number of effective resistors is three, and the effective resistors are the first resistor R1, the second resistor R2 and the third resistor R3, respectively. At this time, the equivalent resistor is a resistor after a circuit obtained after the first resistor R1 and the second resistor R2 are connected in series and the third resistor R3 are connected in parallel, and is denoted as an equivalent resistor Re3.

When the fourth switch K4 and the fifth switch K5 are both turned off, the number of effective resistors is four, and the effective resistors are the first resistor R1, the second resistor R2, the third resistor R3 and the fourth resistor R4, respectively. At this time, the equivalent resistor is a resistor after a circuit obtained after the first resistor R1 and the second resistor R2 are connected in series and a circuit obtained after the third resistor R3 and the fourth resistor R4 are connected in series are connected in parallel, and is denoted as an equivalent resistor Re4.

It can be seen that in the first connection state, a total of four equivalent resistors may be obtained. The resistor set in the first connection state includes the four equivalent resistors Re1, Re2, Re3 and Re4.

With regard to the second connection state, four equivalent resistors in the second connection state may be obtained in the same manner, which is within the scope of the present disclosure and will not be described in detail herein.

To sum up, one resistor set can be determined in each of the M connection states. For example, in the above embodiment, one resistor set may be determined in the two states, namely, the first connection state and the second connection state, and a total of two resistor sets are determined. Therefore, when there are a total of M connection states, M resistor sets may be obtained.

Step 803: determining, based on a preset target set, a first resistor set matching the target set in the M resistor sets.

In an embodiment, a matching degree between each of the M resistor sets and the target set is acquired, and the resistor set having the highest matching degree in the M resistor sets is taken as the first resistor set matching the target set;

where the target set may be set according to the situations of practical applications, which is not specifically limited in the embodiment of the present disclosure. For example, the target set may be designed based on a ratio of an actual voltage of the battery to be discharged and a required target discharging current.

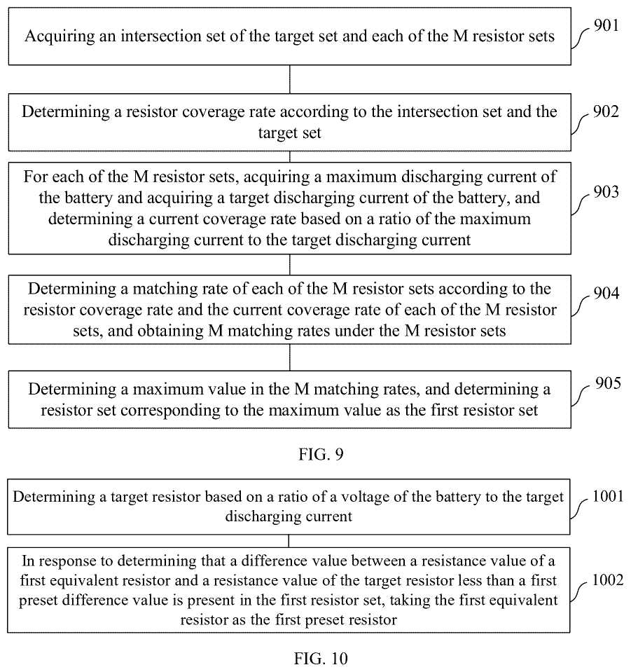

In some embodiments, as shown in FIG. 9, in step 803, the process of determining, based on a preset target set, a first resistor set matching the target set in the M resistor sets, includes the following steps.

Step 901: acquiring an intersection set of the target set and each of the M resistor sets.

In an embodiment, the intersection set of the target set and each of the M resistor sets may be acquired by the following formula:

$$rad ( a ) = r Set ⋂ r ( a ) Set \qquad ( 1 )$$

where rSet is the target set, r(a) Set is an ath resistor set, rad(a) is the intersection set of the target set and the ath resistor set, and a is an integer≤M. Specifically, the first preset resistor set rSet includes at least one resistor, and the intersection set of the target set and the ath resistor set is resistors having the same resistance value in the target set and the ath resistor set. The intersection set of the target set and each of the M resistor sets can be obtained by assigning 1 to M to a respectively, and substituting it into Formula (1) sequentially.

Step 902: determining a resistor coverage rate according to the intersection set and the target set.

In some embodiments, the resistor coverage rate may be obtained by the following formula:

rp(a)=(rad(a)max−rad(a)min)/(rmax−rmin) (2)

where rp(a) is the resistor coverage rate, rad(a) max is a maximum value in the intersection set rad(a), rad(a) min is a minimum value in the intersection set rad(a), rmax is a maximum value in the target set rSet, and rmin is a minimum value in the target set rSet. A numerator in Formula (2) is a range of the intersection set of the target set and the ath resistor set, a denominator in Formula (2) is a range of the target set, and a ratio of the above two ranges is the resistor coverage rate. The resistor coverage rate of each of the M resistor sets can be obtained by assigning 1 to M to a respectively, and substituting it into Formula (2) sequentially.

The resistor coverage rate is used for determining the matching degree between each of the M resistor sets and the target set. For example, in some embodiments, the target set includes a resistance range of 10 Ohms to 90 Ohms, while the intersection set of the target set and the ath resistor set includes a resistance range of 20 Ohms to 60 Ohms, and then the resistor coverage rate rp(a) of the ath resistor set is (90-10)/(60-20)=2.

Step 903: for each of the M resistor sets, acquiring a maximum discharging current of the battery and acquiring a target discharging current of the battery, and determining a current coverage rate based on a ratio of the maximum discharging current to the target discharging current.

In an embodiment, the current coverage rate may be obtained by the following formula:

$$ip ( a ) = i ( a ) max / i Set \qquad ( 3 )$$

where ip(a) is the current coverage rate, i(a) max is the maximum discharging current which may be obtained by adopting the ath resistor set when discharging the battery, and iSet is the target discharging current of the battery. The current coverage rate of each of the M resistor sets can be obtained by assigning 1 to M to a respectively, and substituting it into Formula (3) sequentially.

The current coverage rate is used for determining the matching degree between the maximum discharging current and the target discharging current.

Step 904: determining a matching rate of each of the M resistor sets according to the resistor coverage rate and the current coverage rate of each of the M resistor sets, and obtaining M matching rates under the M resistor sets.

Step 905: determining a maximum value in the M matching rates, and determining a resistor set corresponding to the maximum value as the first resistor set.

In one embodiment, the matching rate of the ath resistor set is determined by the following formula:

$$p ( a ) = X * rp ( a ) + Y * ip ( a ) \qquad ( 4 )$$

where X, Y are both coefficients, and X+Y=1.

In this embodiment, the matching rate of each of the M resistor sets can be obtained by assigning 1 to M to a respectively, and substituting it into Formula (4) sequentially, and a total of M matching rates may be obtained. In this embodiment, the influence of the resistor coverage rate and the current coverage rate is comprehensively considered, and the resistor set with a relatively high matching degree with the target set in practical applications can be acquired.

In some embodiments, the resistor coverage rate may be preferably considered, and then the proportion of the resistor coverage rate should be increased, at this time, X is greater than 0.5 and Y is less than 0.5. For example, X=0.7, and Y=0.3. Of course, in other embodiments, other numerical values may also be adopted for X and Y, which is not specifically limited in the embodiment of the present disclosure.

Then, the obtained M matching rates are compared in magnitude, where the resistor set with the maximum matching rate is the first resistor set. For example, in some embodiments, M=3. That is, there are a total of three resistor sets, the calculated matching rate of the first resistor set is P1, the calculated matching rate of the second resistor set is P2, and the calculated matching rate of the third resistor set is P3, where P1<P2<P3. Then the third resistor set is taken as the first resistor set.

In the embodiment shown in FIG. 9, it is achieved that the matching rate with the target set is calculated based on the existing resistor set, and the resistor set with the highest matching rate with the target set is used as the first resistor set actually used. On the one hand, even if different application scenes need to be provided with different target sets, the battery discharging circuit according to the embodiment of the present disclosure can determine the first resistor set corresponding to the target set, namely, the battery discharging circuit can be applicable to various application scenes, and does not need to replace components, thereby having a relatively high applicability; and on the other hand, obtaining the resistor set with the maximum matching rate in various resistor sets helps control the discharging current of the battery to be close to or equal to the required target discharging current, so as to maintain the battery to be discharged rapidly and stably, thereby improving the efficiency and stability of the battery discharging circuit.

Step 804: acquiring a first preset resistor in the first resistor set;

where the battery is discharged through the first preset resistor.

In one embodiment, as shown in FIG. 10, in step 804, the process of acquiring a first preset resistor in the first resistor set, includes the following steps.

Step 1001: determining a target resistor based on a ratio of a voltage of the battery to the target discharging current.

Step 1002: in response to determining that an absolute value of a difference value between a resistance value of a first equivalent resistor and a resistance value of the target resistor less than a first preset difference value is present in the first resistor set, taking the first equivalent resistor as the first preset resistor;

where the first preset difference value may be set according to the situations of practical applications, which is not specifically limited in the embodiment of the present disclosure. For example, in one embodiment, the first preset difference value is set to 0.1 Ohm, and if one equivalent resistor (namely, a first equivalent resistor) having a resistance value of 10 Ohms is present in the first resistor set, and a resistance value of the target resistor is 10 Ohms, the absolute value of the difference value between the first equivalent resistor and the target resistor is 0, which is less than 0.1 Ohm. At this time, the first equivalent resistor is taken as the first preset resistor.

In another embodiment, the circuit control method further includes the following steps: if the first equivalent resistor is absent in the first resistor set, and J resistors having resistance values less than the resistance value of the target resistor are present in the first resistor set, acquiring a second equivalent resistor, where the second equivalent resistor is a resistor having a maximum resistance value in the J resistors, and J is an integer being ≥1; determining power on the switch branch based on a current discharging current of the battery, the voltage of the battery, and the second equivalent resistor; and if the power is less than or equal to rated power of the switch branch, taking the second equivalent resistor as the first preset resistor.

In this embodiment, J resistors are present in the first resistor set, and the resistance values of the J resistors are all less than the resistance value of the target resistor. The resistor having the largest resistance value in the J resistors is taken as the second equivalent resistor, and the second equivalent resistor is substituted into the following formula to calculate the power on the switch branch:

$$P ( v , i 0 ) = vi 0 - i 02 R 2 \qquad ( 5 )$$

where P(v, i0) is the power on the switch branch, v is the voltage of the battery, i0 is the current discharging current of the battery, and R2 is the resistance value of the second equivalent resistor. If the power calculated according to Formula (5) is less than or equal to the rated power of the switch branch, the second equivalent resistor is taken as the first preset resistor.

For example, in one embodiment, the first preset difference value is set to be 0.1 Ohm. The first resistor set includes three equivalent resistances having resistance values of 5 Ohms, 10 Ohms and 20 Ohms, respectively, and the target resistor is 15 Ohms. The absolute values of the difference values between the resistance values of various equivalent resistors in the first resistor set and the resistance value of the target resistor are 10, 5 and 5, respectively, which are all greater than 0.1. At this time, it is necessary to further judge whether J resistors having resistance values less than the resistance value of the target resistor are present in the first resistor set. Since the resistance values of two equivalent resistors having resistance values of 5 Ohms and 10 Ohms respectively are both less than the resistance value of the target resistor, J resistors having resistance values less than the resistance value of the target resistor are present in the first resistor set, and J=2. Meanwhile, the equivalent resistor having a resistance value of 10 Ohms is the resistor having the minimum resistance value in the J resistors (including the two equivalent resistances having the resistance values of 5 Ohms and 10 Ohms, respectively), so that the equivalent resistor having the resistance value of 10 Ohms is a second equivalent resistor.

Then, when the second equivalent resistor is present, the current discharging current of the battery is determined based on the ratio of the voltage of the battery to the resistance value of the second equivalent resistor, and the power on the switch branch can be calculated by substituting the current discharging current of the battery and the resistance value of the second equivalent resistor into Formula (5). If the power on the switch branch is not greater than (less than or equal to) the rated power of the switch branch, it can be determined that the switch branch can work safely, and the switch branch will not be damaged due to excessive power. Thus, it can be determined that the resistance value of the second equivalent resistor selected at this time is applicable to the current application scene, and the second equivalent resistor may be taken as the first preset resistor. In this embodiment, it is preferable to select the resistor having the resistance value less than the resistance value of the target resistor, so that a sufficient discharging current can be obtained to satisfy that the discharging current of the battery is close to or equal to the required target discharging current.

In another embodiment, the circuit control method further includes the following steps: if the first equivalent resistor and the second equivalent resistor are absent in the first resistor set, and L resistors having resistance values greater than the resistance value of the target resistor are present in the first resistor set, acquiring a third equivalent resistor, and taking the third equivalent resistor as the first preset resistor, where the third equivalent resistor is a resistor having a minimum resistance value in the L resistors, and L is an integer ≥1.

In an embodiment, if the first equivalent resistor and the second equivalent resistor are absent in the first resistor set, there is no resistance value of the resistor less than the resistance value of the target resistor in the first resistor set, and then there are resistance values of the L resistors greater than the resistance value of the target resistor in the first resistor set. Moreover, the resistor having the minimum resistance value in the L resistors is taken as the third equivalent resistor. The third equivalent resistor satisfies not only that the resistance value thereof is greater than the resistance value of the target resistor but also that the resistance value thereof is closest to the resistance value of the target resistor.

For example, in one embodiment, the first preset difference value is set to be 0.1 Ohm. The first resistor set includes three equivalent resistors having resistance values of 8 Ohms, 10 Ohms and 20 Ohms, respectively, and the target resistor is 6 Ohms. The absolute values of the difference values between the resistance values of various equivalent resistors in the first resistor set and the resistance value of the target resistor are 2, 4 and 14, respectively, which are all greater than 0.1, and the first equivalent resistor is absent in the first resistor set. Moreover, at this time, there is no resistance of less than 6 Ohms in the first resistor set, namely, the second equivalent resistor is absent in the first resistor set. Since the resistance values of the three equivalent resistors having the resistance values of 8 Ohms, 10 Ohms and 20 Ohms respectively are all greater than the resistance value of the target resistor, there are L resistors having the resistance values greater than the resistance value of the target resistor in the first resistor set, and L=3. Meanwhile, the equivalent resistor having the resistance value of 8 Ohms is the resistor having the minimum resistance value in the L resistors (including three equivalent resistances having the resistance values of 8 Ohms, 10 Ohms and 20 Ohms, respectively), so that the equivalent resistor having the resistance value of 8 Ohms is the third equivalent resistor.

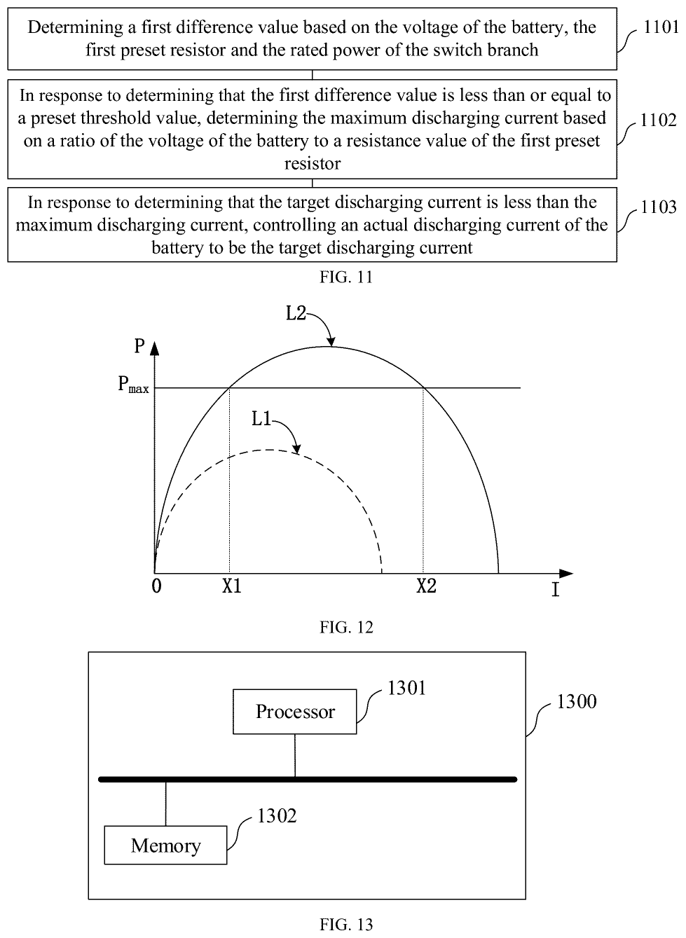

In one embodiment, as shown in FIG. 11, after executing step 804, the circuit control method further includes the following steps.

Step 1101: determining a first difference value based on the voltage of the battery, the first preset resistor and the rated power of the switch branch.

In some embodiments, the first difference value may be calculated by the following formula:

$$Δ = v 2 - 4 R 0 P max \qquad ( 6 )$$

where Δ is the first difference value, v is the voltage of the battery, R0 is the resistance value of the first preset resistor, and Pmax is the rated power of the switch branch.

Step 1102: in response to determining that the first difference value is less than or equal to a preset threshold value, determining the maximum discharging current based on a ratio of the voltage of the battery to a resistance value of the first preset resistor.

Step 1103: in response to determining that the target discharging current is less than the maximum discharging current, controlling an actual discharging current of the battery to be the target discharging current;

where the preset threshold value may be set according to the situations of practical applications, which is not specifically limited in the embodiment of the present disclosure. In some embodiments, the preset threshold value may be set to be 0.

Taking the preset threshold value being set to be 0 as an example, referring to FIG. 11 and FIG. 12 jointly, the abscissa represents the current, and the ordinate represents the power. When the first difference value Δ is not greater than 0, a curve of the first difference value Δ is a curve L1. At this time, the first difference value Δ is less than the rated power Pmax of the switch branch on the whole, and it can be determined that the actual power of the switch branch is always less than the rated power in this case, namely, the discharging power of the switch branch can be ensured within a safe working range, so that the switch branch may be prevented from being broken down, so as to prolong the service life of the switch branch and improve the working stability of the battery discharging circuit.

In another embodiment, the circuit control method further includes the following steps: if the first difference value is greater than the preset threshold value, determining two discharging currents of the battery based on the current discharging current of the battery, the voltage of the battery, the resistance value of the first preset resistor and the rated power of the switch branch; if the target discharging current is less than or equal to a first discharging current in the two discharging currents, or the target discharging current is not less than a second discharging current in the two discharging currents, controlling the actual discharging current of the battery to be the target discharging current; and if the target discharging current is greater than the first discharging current and the target discharging current is less than the second discharging current, controlling the actual discharging current of the battery to be the first discharging current, where the first discharging current is less than the second discharging current.

In some embodiments, the two discharging currents may be determined by the following formula:

$$- R 0 * i 12 + v * i 1 - P max = 0 \qquad ( 7 )$$

where i1 is the current discharging current of the battery, R0 is the resistance value of the first preset resistor, v is the voltage of the battery, and Pmax is the rated power of the switch branch.

Referring again to FIG. 12, when the first difference value Δ is greater than 0, the curve of the first difference value Δ is the curve L2. The curve L2 intersects the rated power Pmax at two intersection points, and the abscissas of the two intersection points are X1 and X2, respectively. X1 and X2 are two roots of —R0*i12+v*i1-Pmax=0, and X1 and X2 are also the two discharging currents determined by Formula (7). That is, based on the current discharging current of the battery, the voltage of the battery, the resistance value of the first preset resistor and the rated power of the switch branch, it is determined that the two discharging currents of the battery are the first discharging current X1 and the second discharging current X2, respectively. When the target discharging current is less than or equal to the first discharging current X1, or the target discharging current is greater than or equal to the second discharging current X2, it can be seen from FIG. 12 that the curve L2 is always maintained to be less than the rated power Pmax, namely, it can also continue to maintain the actual power of the switch branch to always not exceed the rated power, and at this time, the actual discharging current of the battery is controlled to be the target discharging current. When the target discharging current is greater than the first discharging current X1 and the target discharging current is less than the second discharging current X2, the actual discharging current of the battery needs to be set to be the first discharging current X1, so as to ensure that the actual power of the switch branch always does not exceed the rated power. Through the above process, the discharging power of the switch branch may also be controlled to be always within a safe working range, so that the switch branch may be prevented from being broken down, so as to prolong the service life of the switch branch and improve the working stability of the battery discharging circuit.

FIG. 13 is a structure of a controller according to another embodiment of the present disclosure, where a Microcontroller Unit (MCU) or a Digital Signal Processing (DSP) controller, and the like may be adopted as the controller 1300.

As shown in FIG. 13, the controller 1300 includes at least one processor 1301 and a memory 1302, where the memory 1302 may be internal to the controller 1300 or external to the controller 1300, and the memory 1302 may also be a remotely provided memory which is connected to the controller 1300 via a network.

As a non-volatile computer-readable storage medium, the memory 1302 may be used for storing non-volatile software programs, non-volatile computer-executable programs and modules. The memory 1302 may include a program storage area and a data storage area, where the program storage area may store an operating system and an application program required by at least one function; and the data storage area may store data created according to the use of a terminal, and the like. In addition, the memory 1302 may include a high-speed random access memory, and may also include a non-volatile memory, such as at least one magnetic disk storage device, a flash memory device, or other non-volatile solid-state memory devices. In some embodiments, the memory 1302 optionally includes memories remotely provided relative to the processor 1301, and these remote memories may be connected to the terminal via the network. Instances of the above network include, but are not limited to, the Internet, an intranet, a local area network, a mobile communication network, and a combination thereof.

The processor 1301 executes various functions of the terminal and processes data by running or executing software programs and/or modules stored in the memory 1302 and calling data stored in the memory 1302 to monitor the terminal on the whole, for example, to implement the circuit control method in any of the embodiments of the present disclosure.

One or more processors 1301 may be provided, and one processor 1301 is taken as an example in FIG. 13. The processor 1301 and the memory 1302 may be connected by a bus or in other means. The processor 1301 may include a central processing unit (CPU), a digital signal processor (DSP), an application specific integrated circuit (ASIC), a controller, a field-programmable gate array (FPGA) device, and the like. The processor 1301 may also be implemented as a combination of computing devices, such as a combination of the DSP and a microprocessor, a plurality of microprocessors, one or more microprocessors in conjunction with a DSP core, or any other such configuration.

In some embodiments, the controller 50 shown in FIG. 1 to FIG. 7 may be implemented as the controller 1300 shown in FIG. 13.

An embodiment of the present disclosure further provides a battery discharging apparatus. The battery discharging apparatus includes the battery discharging circuit 100 in any of the embodiments of the present disclosure, and/or the controller 1300 in any of the embodiments of the present disclosure.

Finally, it should be noted that the above embodiments are merely illustrative of the technical solutions of the present disclosure, and are not limiting thereto; combinations of technical features in the above embodiments or different embodiments are also possible within the spirit of the application, steps may be implemented in any order, and there are many other variations in different aspects of the present disclosure as described above, which are not provided in detail for the sake of brevity; although the present disclosure has been described in detail with reference to the foregoing embodiments, the technical solutions disclosed in the above various embodiments may still be modified, or some of the technical features thereof may be replaced by equivalents; however, these modifications or substitutions do not bring the essence of the corresponding technical solutions out of the scope of the technical solutions of the various embodiments of the present disclosure.

What is claimed is:

1. A battery discharging circuit, comprising:
a resistor configuration branch, a current sampling branch, a switch branch, a signal amplification branch, and a controller;
wherein a first end of the resistor configuration branch is connected with a first end of a battery, a second end of the resistor configuration branch is connected with a first end of the switch branch, a first end of the current sampling branch is connected with a second end of the battery, a second end of the current sampling branch is respectively connected with a second end of the switch branch and a second end of the signal amplification branch, a first end of the signal amplification branch and a third end of the resistor configuration branch are both connected with the controller, and a third end of the signal amplification branch is connected with a third end of the switch branch;
wherein the resistor configuration branch is controlled by the controller and configured as a first preset resistor;
wherein the current sampling branch is used for sampling a discharging current of the battery and outputting a sampling signal;
wherein the controller is used for outputting a voltage signal corresponding to a target discharging current of the battery;
wherein the signal amplification branch is used for receiving the sampling signal and the voltage signal and outputting a regulation signal;
wherein the switch branch is used for receiving the regulation signal and regulating a turn-on degree of the switch branch based on the regulation signal; and
wherein the battery is discharged through the first preset resistor and the switch branch, and the discharging current of the battery has a positive correlation with the turn-on degree of the switch branch.

2. The battery discharging circuit according to claim 1, wherein the resistor configuration branch comprises N resistor assemblies and a line connection switching branch, any resistor assembly in the N resistor assemblies comprises one or more resistors, and Nis an integer ≥1;
wherein the line connection switching branch is respectively connected with the N resistor assemblies, the controller, the first end of the battery, and the first end of the switch branch; and
wherein the line connection switching branch is controlled by the controller, and the line connection switching branch is used for switching a connection relationship between resistor assemblies in the N resistor assemblies and generating the first preset resistor.

3. The battery discharging circuit according to claim 2, wherein the N resistor assemblies comprise a first resistor assembly and a second resistor assembly, and the line connection switching branch comprises a first switch, a second switch and a third switch;
wherein a first end of the first resistor assembly is respectively connected with a first end of the first switch and the first end of the battery, a second end of the first switch is respectively connected with a first end of the second resistor assembly and a first end of the second switch, a second end of the second switch is respectively connected with a second end of the first resistor assembly and a first end of the third switch, a second end of the third switch is respectively connected with a second end of the second resistor assembly and the first end of the switch branch, and the first switch, the second switch and the third switch are all connected with the controller; and
wherein the controller is configured to switch a connection relationship between the first resistor assembly and the second resistor assembly by controlling one or more of the first switch, the second switch and the third switch to turn on or off.

4. The battery discharging circuit according to claim 3, wherein the first resistor assembly comprises a first resistor, a second resistor and a fourth switch, and the second resistor assembly comprises a third resistor, a fourth resistor and a fifth switch; and
wherein the first resistor is connected in series with the second resistor, the second resistor is connected in parallel with the fourth switch, a non-series connection end of the first resistor is the first end of the first resistor assembly, a non-series connection end of the second resistor is the second end of the first resistor assembly, the third resistor is connected in series with the fourth resistor, the fourth resistor is connected in parallel with the fifth switch, a non-series connection end of the third resistor is the first end of the second resistor assembly, and a non-series connection end of the fourth resistor is the second end of the second resistor assembly.

5. The battery discharging circuit according to claim 1, wherein the current sampling branch comprises a first sampling resistor; and
wherein a first end of the first sampling resistor is connected with the second end of the battery, and a second end of the first sampling resistor is connected with the second end of the switch branch.

6. The battery discharging circuit according to claim 1, wherein the switch branch comprises a first switch transistor; and
wherein a first end of the first switch transistor is connected with the third end of the signal amplification branch, a second end of the first switch transistor is connected with the second end of the current sampling branch, and a third end of the first switch transistor is connected with the second end of the resistor configuration branch.

7. The battery discharging circuit according to claim 1, wherein the signal amplification branch comprises a first amplification assembly and a second amplification assembly;
wherein a first end of the first amplification assembly is connected with the second end of the switch branch, a second end of the first amplification assembly is connected with a first end of the second amplification assembly, a second end of the second amplification assembly is connected with the controller, and a third end of the second amplification assembly is connected with the third end of the switch branch; and
wherein the first amplification assembly is used for receiving the sampling signal and amplifying the sampling signal; and
wherein the second amplification assembly is used for receiving the voltage signal and the sampling signal amplified by the first amplification assembly, and outputting the regulation signal.

8. The battery discharging circuit according to claim 7, wherein the first amplification assembly comprises a first operational amplifier, a fifth resistor and a sixth resistor; and
wherein a first input end of the first operational amplifier is connected with the second end of the switch branch, a second input end of the first operational amplifier is connected with a first end of the fifth resistor and a first end of the sixth resistor, an output end of the first operational amplifier is connected with a second end of the fifth resistor and the first end of the second amplification assembly, and a second end of the sixth resistor is grounded.

9. The battery discharging circuit according to claim 7, wherein the second amplification assembly comprises a seventh resistor, an eighth resistor, a ninth resistor, a first capacitor, a second capacitor, a third capacitor and a second operational amplifier; and
wherein a first end of the seventh resistor is connected with the second end of the first amplification assembly, a second end of the seventh resistor is respectively connected with a first end of the eighth resistor, a first end of the first capacitor, a first end of the second capacitor and a second input end of the second operational amplifier, a second end of the eighth resistor is respectively connected with a first end of the ninth resistor and the controller, a second end of the ninth resistor is respectively connected with a second end of the first capacitor, a first end of the third capacitor and a first input end of the second operational amplifier, an output end of the second operational amplifier is respectively connected with a second end of the second capacitor and the third end of the switch branch, and a second end of the third capacitor is grounded.

10. A circuit control method, applied to a battery discharging circuit, comprising:
switching a connection relationship between resistor assemblies in N resistor assemblies of a resistor configuration branch to obtain M connection states of the N resistor assemblies, wherein M and N are both integers ≥1, wherein the battery discharging circuit comprises the resistor configuration branch, a current sampling branch, a switch branch, a signal amplification branch and a controller, wherein a first end of the resistor configuration branch is connected with a first end of a battery, a second end of the resistor configuration branch is connected with a first end of the switch branch, a first end of the current sampling branch is connected with a second end of the battery, a second end of the current sampling branch is respectively connected with a second end of the switch branch and a second end of the signal amplification branch, a first end of the signal amplification branch and a third end of the resistor configuration branch are both connected with the controller, and a third end of the signal amplification branch is connected with a third end of the switch branch; wherein the resistor configuration branch is controlled by the controller and configured as a first preset resistor, wherein the current sampling branch is used for sampling a discharging current of the battery and outputting a sampling signal; wherein the controller is used for outputting a voltage signal corresponding to a target discharging current of the battery; the signal amplification branch is used for receiving the sampling signal and the voltage signal and outputting a regulation signal, wherein the switch branch is used for receiving the regulation signal and regulating a turn-on degree of the switch branch based on the regulation signal, and wherein the battery is discharged through the first preset resistor and the switch branch, and the discharging current of the battery has a positive correlation with the turn-on degree of the switch branch;
for one or more connection states of the M connection states, changing a number of effective resistors in the N resistor assemblies, determining a resistor set in the one or more connection states, and obtaining M resistor sets in the M connection states;
determining, based on a preset target set, a first resistor set matching the preset target set in the M resistor sets; and
acquiring a first preset resistor in the first resistor set, wherein the battery is discharged through the first preset resistor.

11. The circuit control method according to claim 10, wherein determining, based on the preset target set, the first resistor set matching the preset target set in the M resistor sets comprises:
acquiring an intersection set of the preset target set and one or more resistor sets of the M resistor sets;
determining a resistor coverage rate according to the intersection set and the preset target set;
for the one or more resistor sets, acquiring a maximum discharging current of the battery and acquiring a target discharging current of the battery, and determining a current coverage rate based on a ratio of the maximum discharging current to the target discharging current;
determining a matching rate of the one or more resistor sets according to the resistor coverage rate and the current coverage rate of the one or more resistor sets, and obtaining M matching rates under the M resistor sets; and
determining a maximum value in the M matching rates, and determining a resistor set corresponding to the maximum value as the first resistor set.

12. The circuit control method according to claim 10, wherein acquiring the first preset resistor in the first resistor set comprises:
determining a target resistor based on a ratio of a voltage of the battery to the target discharging current of the battery; and
in response to determining that a first equivalent resistor is present in the first resistor set and an absolute value of a difference value between a resistance value of the first equivalent resistor and a resistance value of the target resistor less than a first preset difference value is present in the first resistor set, taking the first equivalent resistor as the first preset resistor.

13. The circuit control method according to claim 12, further comprising:
in response to determining that the first equivalent resistor is absent in the first resistor set, and J resistors having resistance values less than the resistance value of the target resistor are present in the first resistor set, acquiring a second equivalent resistor, wherein the second equivalent resistor is a resistor having a maximum resistance value in the J resistors, and J is an integer ≥1;
determining power on the switch branch based on a current discharging current of the battery, the voltage of the battery, and the second equivalent resistor; and
in response to determining that the power is less than or equal to rated power of the switch branch, taking the second equivalent resistor as the first preset resistor.

14. The circuit control method according to claim 13, further comprising:
in response to determining that the first equivalent resistor and the second equivalent resistor are absent in the first resistor set, and L resistors having resistance values greater than the resistance value of the target resistor are present in the first resistor set, acquiring a third equivalent resistor, and taking the third equivalent resistor as the first preset resistor, wherein the third equivalent resistor is a resistor having a minimum resistance value in the L resistors, and L is an integer ≥1.

15. The circuit control method according to claim 10, wherein after acquiring the first preset resistor in the first resistor set, the method further comprises:
determining a first difference value based on a voltage of the battery, the first preset resistor and rated power of the switch branch;
in response to determining that the first difference value is less than or equal to a preset threshold value, determining the maximum discharging current based on a ratio of the voltage of the battery to a resistance value of the first preset resistor;
in response to determining that the target discharging current of the battery is less than the maximum discharging current, controlling an actual discharging current of the battery to be the target discharging current; and
in response to determining that the target discharging current is greater than or equal to the maximum discharging current, controlling the actual discharging current of the battery to be the maximum discharging current.

16. The circuit control method according to claim 15, further comprising:
in response to determining that the first difference value is greater than the preset threshold value, determining two discharging currents of the battery based on the current discharging current of the battery, the voltage of the battery, the resistance value of the first preset resistor and the rated power of the switch branch;
in response to determining that the target discharging current is less than or equal to a first discharging current in the two discharging currents, or the target discharging current is greater than or equal to a second discharging current in the two discharging currents, controlling the actual discharging current of the battery to be the target discharging current, wherein the first discharging current is less than the second discharging current; and
in response to determining that the target discharging current is greater than the first discharging current and the target discharging current is less than the second discharging current, controlling the actual discharging current of the battery to be the first discharging current.

17. A controller, comprising:
at least one processor and a memory communicatively connected with the at least one processor, wherein the memory stores instructions executable by the at least one processor, and the instructions are executed by the at least one processor to cause the at least one processor to perform acts comprising:
switching a connection relationship between resistor assemblies in N resistor assemblies of a resistor configuration branch to obtain M connection states of the N resistor assemblies, wherein M and N are both integers ≥1, wherein the battery discharging circuit comprises the resistor configuration branch, a current sampling branch, a switch branch, a signal amplification branch and a controller, wherein a first end of the resistor configuration branch is connected with a first end of a battery, a second end of the resistor configuration branch is connected with a first end of the switch branch, a first end of the current sampling branch is connected with a second end of the battery, a second end of the current sampling branch is respectively connected with a second end of the switch branch and a second end of the signal amplification branch, a first end of the signal amplification branch and a third end of the resistor configuration branch are both connected with the controller, and a third end of the signal amplification branch is connected with a third end of the switch branch, wherein the resistor configuration branch is controlled by the controller and configured as a first preset resistor, the current sampling branch is used for sampling a discharging current of the battery and outputting a sampling signal, wherein the controller is used for outputting a voltage signal corresponding to a target discharging current of the battery, wherein the signal amplification branch is used for receiving the sampling signal and the voltage signal and outputting a regulation signal, wherein the switch branch is used for receiving the regulation signal and regulating a turn-on degree of the switch branch based on the regulation signal, and wherein the battery is discharged through the first preset resistor and the switch branch, and the discharging current of the battery has a positive correlation with the turn-on degree of the switch branch;
for one or more connection states of the M connection states, changing a number of effective resistors in the N resistor assemblies, determining a resistor set in the one or more connection states, and obtaining M resistor sets in the M connection states;
determining, based on a preset target set, a first resistor set matching the preset target set in the M resistor sets; and
acquiring a first preset resistor in the first resistor set, wherein the battery is discharged through the first preset resistor.
